(19) United States
(12) Patent Application Publication
(10) Pub. No.: US 2026/0205252 A1
(43) Pub. Date: Jul. 16, 2026

(54) INTEGRATED SENSING AND COMMUNICATIONS IN SUB BAND FULL DUPLEX TRANSMISSION ENVIRONMENTS

(71) Applicant: Oswego Technologies LLC, columbus, NJ (US)

(72) Inventor: Brian Gordaychik, columbus, NJ (US)

(21) Appl. No.: 19/418,406

(22) Filed: Dec. 12, 2025

Related U.S. Application Data
(60) Provisional application No. 63/745,605, filed on Jan. 15, 2025.
(60) Provisional application No. 63/757,179, filed on Feb. 11, 2025.
(60) Provisional application No. 63/769,032, filed on Mar. 9, 2025.

(51) Int. Cl. H04L 5/14; H04B 1/38; H04W 72/0446

(52) U.S. Cl. CPC H04L 5/14; H04B 1/38; H04W 72/0446

(57) ABSTRACT

A wireless device may be configured to perform joint integrated sensing and communications. The wireless device may comprise a processor configured to process sensing-specific symbol/slot structures and a transceiver configured to transmit a sensing signal based on the sensing-specific symbol/slot structures. A time gap may be specified before and after the sensing signal. A symbol boundary of the sensing-specific symbol/slot structures is not impacted from a communication perspective.

### CROSS REFERENCE TO RELATED APPLICATIONS

This application claims priority to U.S. Provisional Application No. 63/745,605 filed on Jan. 15, 2025, U.S. Provisional Application No. 63/757,179 filed on Feb. 11, 2025 and U.S. Provisional Application No. 63/769,032 filed on Mar. 9, 2025, the contents of each of which is incorporated herein by way of reference in its entirety.

### SUMMARY

A wireless device may be configured to perform joint integrated sensing and communications. The wireless device may comprise a processor configured to process sensing-specific symbol/slot structures and a transceiver configured to transmit a sensing signal based on the sensing-specific symbol/slot structures. A time gap may be specified before and after the sensing signal. A symbol boundary of the sensing-specific symbol/slot structures is not impacted from a communication perspective.

The sensing-specific symbol/slot structures include a sensing-specific symbol/slot that includes sensing and communication signals transmitted in a time duplex manner in portions of a SBFD slot, wherein the portions represent a subset of the SBFD slot.

The sensing-specific symbol/slot structures include a sensing-specific symbol/slot that dedicate a subband to sensing only and another subband to communication only.

The sensing-specific symbol/slot structures include a sensing-specific symbol/slot that includes a gap that spans a frequency of the slot and a gap that spans a time component of the slot.

A transceiver may be configured to process a first in time downlink (DL) resource region followed by a second in time sub band full duplex (SBFD) time/frequency resource region comprised of DL, UL and DL regions and subsequently a third uplink (UL) resource region, wherein the DL resource region and the UL resource region are shorter in time duration than the SBFD resource region, wherein the SBFD resource region includes information spread over the region which is scheduled by a single DCI, wherein the UL resource region includes information scheduled separately.

The information scheduled in the UL resource region is scheduled by a preceding DL region.

### BRIEF DESCRIPTION OF THE DRAWINGS

FIG. 1 shows example slot structures that include sensing and/or communications signaling; and

FIG. 2 shows an embodiment wherein time/frequency resources are divided into sets such that a first downlink slot may be a set, a series of SBFD slots may be divided into sets including i) an upper band DL set, ii) a middle band UL set and iii) a lower band DL set.

### DETAILED DESCRIPTION

Integrated sensing is a wireless communications technique that enables simultaneous object sensing and communication with ground and other stations. Applications include tracking drones, people, packages, vehicles, roadway objects, train rail conditions, cranes, farm machinery, animals, and more. The technology provides a foundation for advanced safety, tracking, and monitoring systems across diverse industries and use cases.

A sensing function (SF) performs the management of sensing services by receiving delay, Doppler, and angle information from gNBs or antenna units, then providing results including position, velocity, and sensing target data. Each operator network may comprise one or more managing sensing functions (MSFs) which manage one or more SFs. The MSF may be located in the core network or elsewhere and handles SF instantiation and management across the network infrastructure.

SFs can be instantiated on-demand at various locations including user equipment (either in coverage or out of coverage), base stations (at the gNB, BBU, or AAU), core network elements, and edge network elements or functions. The location choice has significant implications for latency and security as it relates to sensing measurement inputs and sensing results. Depending on the type of sensing being performed and where the sensing transceiver is placed, various sensing function configurations may be necessary.

Network elements report their sensing capabilities to enable optimal configuration and resource allocation. For instance, a gNB may report the capability of BBU/AAU functions to instantiate one or more SFs on-demand, or it may be reported that SF logic is available at the gNB. Similarly, roadside units and other transceivers may have more limited or no wireless data transmission capability and may report transceiver capabilities that relate primarily to sensing functionality. Devices may have ISAC capability, but the capability of sensing versus data may be limited or exceed a limit. For instance, devices may have capabilities to perform sensing in a particular direction, angle, or beam set, and may have capabilities of adjusting these parameters.

The system ensures latency and QoS guarantees through association between latency, QoS, sensing event detection, and signaling resources. When latency exceeds a threshold, there may be joint processing and joint sensing operations performed. In high latency scenarios, such as when detecting potential collision scenarios where latency may exceed a threshold, the base station may be configured to provide raw inputs to multiple sensing functions as specified by the MSF or application server. For instance, the base station may provide raw input to a UE in communication range which has an instantiated sensing function and sufficient power level to process the raw input, another base station neighbor, the MSF for distribution, the core network, and other elements. All of the raw input may be sent to all SFs, or all raw input may be sent to the MSF for dividing into different chunks for processing at different SFs.

Each distributed SF may apply different classification approaches and may assign different probabilities to an object being identified or detected. Each probability may be summed mathematically, and in cases where the number of SFs utilized exceeds a threshold, one or more results from one or more SFs may be dropped. In contrast, in low latency scenarios such as package tracking or identifying objects of little importance, latency may be below a threshold and such processing may be delayed for a period by sending raw data for processing at a core network or application server outside of the core network, potentially outside of the cellular network.

The sensing configuration provided to a base station or other transceiver station by an MSF, SF, or UE includes an SF identifier and a sensing resource list with parameters including sensing QoS and periodicity, latency, direction, angle, beam pattern, object and location pair association, time of day, sweep periodicity, sweep angle, sweep altitude, stop conditions, and start conditions. The object and location pair association may be an identifier used in a lookup table to identify the object/pair combination.

An application server, MSF, and SF may expose an interface for configuring various parameters including the availability of configuration (who and when they may provide configuration information), login information such as passwords, an association between a user and one or more base stations within an area, sensing categories including types and sizes of objects to sense, and latency required for sensing certain objects in given areas or based on an object and location pair association. For instance, the notion that a flock of birds are located by a gNB is irrelevant in many cases, however, a flock of birds near an airport may be of critical importance, and a flock of birds near an airplane at takeoff is a major concern. Therefore, gNBs, SFs, and managing SFs need to be programmed in terms of what is relevant to the particular areas, directions, and altitudes in which they are located.

Examples of object and location pair associations include deer/roadway, deer/shoulder, crash/roadway, crash/shoulder, drone/airport range, intruder/perimeter side, and similar combinations that provide context-aware sensing priorities. An API may allow a user to configure the sensing periodicity, object and location pair association, latency, sensing area, sensing direction, beams, and related parameters to optimize system performance for specific use cases.

Sensing may be tied to a particular beam sweeping procedure like SSB, or beam sweeping for SSB may be configured at a different periodicity or included with a different sweeping procedure. A managing SF may divide certain tasks among a plurality of transceivers. For instance, for checking for deer along a highway, there may be a plurality of roadside transceivers where a single sensing function supports a base station and two roadside units. The sensing function may configure the first (left) roadside unit with three beams: one longer and two shorter beams at configured directions and widths. The SF may configure the base station with two sets of beam sweeping parameters where the first set of road-facing beams may be swept at a periodicity configured at a given latency or QoS because these beams are used for sweeping road hazards. The second set of beams are configured at a different lower periodicity and may or may not be made shorter (lower power) or wider for finding threats that may not be as relevant, such as nearby deer which may or may not approach the roadway. For non-urgent threats, a lower QoS may be configured at the transceiver such that scanning may be at lower periodicity, lower power, wider beam, and fewer dedicated sensing resources compared to scenarios where the transceiver is actively scanning the roadway.

When roadside units detect an object of significance, one or both RUs may signal to the base station to increase ISAC searching periodicity in an area for a time based on the object detected, and the base station may extend a beam to match a location or direction of the object. A gNB may instantiate an SF locally depending on certain conditions, for instance if an object is detected and more information needs to be obtained about the object and the surrounding environment. The gNB may detect or determine that a need for an SF dedicated to a certain latency or QoS needs to be instantiated, for instance a high QoS SF where latency is above a first threshold latency, a medium QoS SF where latency is below the first threshold but above a second threshold, and a low QoS SF where latency is below the second threshold. As the gNB has a greater need for high latency traffic, it may instruct medium and low QoS SFs to be moved to the core network. For instance, if a gNB is requested to perform weather monitoring or object detection of low priority, those low-priority tasks may be offloaded to the core network or to another node based on the gNB receiving a request to perform high latency ISAC procedures. SFs or information thereof may be relocated to other base stations in whole or in part, split to multiple different base stations.

Users may upgrade and configure a base station, SF, or MSF with a sensing configuration. For instance, a user may request certain sensing parameters of the base station by sending a sensing request to the base station. The sensing request may request information about the latency, QoS, capabilities, object and location pair association, and other parameters. The base station may respond to the request in a unicast or broadcast manner, for instance if it is expected that multiple UEs may require the same information.

A UE may send a scheduling request to either a gNB or RU, wherein the scheduling request may request a grant for providing sensing feedback information. The scheduling request may provide some indication of a sensed object, and the gNB or RU may provide a grant including a dedicated resource pool to one or more UEs in range based on the scheduling request of the single UE. In combination, the gNB may adjust the size of the pool or allocate a new pool to a group of UEs based on a scheduling request of another UE. As the group of UEs pass the RU or base station (no longer in range of an object but may still be in range), the gNB or RU may deactivate the grant and allocate a grant of similar size or having the same characteristics to a group of UEs which are approaching the object or are just coming into range of the gNB or RU. The base station may signal availability of a pool via SIB, RRC signaling, or DCI signaling depending on latency requirements.

Integrated sensing methods include a method for finding an object comprising identifying an object based on an object identifier, wherein the identifying is by way of photographic detection, numerical detection, object classification, scanning of an identifier, scanning of an RFID tag, or other means. The method includes determining that a UE is requesting access to an integrated sensing and communication (ISAC) service and verifying that the UE is allowed to request sensing information about the object, wherein the verifying includes receiving UE information at a base station and sending the information to a server for confirmation. If the UE is verified, the method includes receiving identifying information about the object from the UE, wherein the identifying information includes one of a photograph or video, object identifier or classification, or RF-related information associated with the object. If the UE is verified, the method includes transmitting sensing reference signals in directions, wherein at least one of the directions is toward the object, and identifying the object based on reception of the reference signals, wherein the reference signals are received at a first base station that sent the reference signals or another base station which either did not send the reference signals or sent other reference signals. If the UE is verified, the method includes providing location information to the UE, the location information specifying location information about the object, wherein the object is located via sensing signals and images.

Carrier frequency offset (CFO) and other device imperfections may be used to aid in location of an object. For example, a server may maintain a table corresponding to a device identifier and CFO per device. The table may be constructed using authenticated transmissions or based on transmissions which are broadcast in the absence of authentication, such as beacons or SSBs. Other imperfections include sampling clock offset, IQ imbalance, power amplifier noise, and phase noise among others. Devices may avoid tracking by encrypting a device address according to a shared key. Each transmission may involve changing an address according to a cryptographic method. When the address changes, the device may also need to modify clock offset, IQ imbalance, power amplifier, and phase noise using a same or different key such that nefarious receivers cannot or may not be able to infer characteristics of a transmitter. In embodiments, such keys may be negotiated between transmitter and receiver in accordance with a maximum allowable delta in terms of noise parameters.

A method for detecting a potential collision of a first car and a second car includes determining that the first car is associated with a first UE and the second car is associated with a second UE, establishing a communication session with the first UE and the second UE, and determining via sensing that the first car and second car are expected to collide. The method includes providing collision information about the second car to the first car and providing collision information about the first car to the second car, wherein collision information is provided to a third car which is not expected to collide with either the first car or the second car, but wherein a fourth car which is not expected to collide is not provided collision information about either the first car or the second car. The method does not provide information about the second car to the first car and does not provide information about the first car to the second car unless and until the determining that the two cars are expected to collide, when a collision threshold exceeds a value. The collision information may include information indicative to instruct airbag deployment.

A method for upgrading an integrated sensing and communication service with scanning object parameters includes determining that a UE is requesting access to an ISAC service, verifying that the UE is allowed to perform an upgrade of the ISAC service, and receiving an indication from the UE to retrieve parameters from a third-party service. The third-party service provides parameters including object search information, time of day search information associated with the object, and locations to search for the object. The method includes receiving access information from the UE or from the third party, the access information indicating one or more receivers which are to be notified in case the object is detected, and updating the ISAC service to reflect searching for the object. Updating the ISAC service includes updating one or more ISAC base stations, sensing-only base stations, roadside units, networking components linking the ISAC base stations to the core network, and core network functions. Updating the ISAC service may cause an ISAC network component to be instantiated and may cause a QoS table to be updated compared to an old QoS table. The method includes detecting an object based on the parameters and providing location information about the detected object to one or more of the receivers which are to be notified. The method may further include receiving information from one of the receivers indicating that such receiver no longer wishes to receive information about an object, determining that one or more receivers are no longer in range of one or more base stations and removing them from those receivers which are to be notified, and determining that one or more receivers have come into range of one or more base stations and adding them to those receivers which are to be notified.

A network may be configured to perform an ISAC service, wherein the service includes one of tracking vehicles, anticipating collisions of vehicles, anticipating that a drone enters a restricted airspace, anticipating that an intruder has accessed a building, or similar applications. The network receives assistance information from an authenticated user, wherein the assistance information comprises information about a location, beam, angle, altitude, UE, vehicle, or similar parameters, and wherein the assistance information comprises QoS information, latency information, and security information. The network updates performance of the ISAC service based on receiving the assistance information, wherein a QoS of the assistance information is greater than another QoS of the ISAC service, and updates the ISAC service such that additional base stations are incorporated due to the higher QoS service. The network updates a search periodicity of certain base stations used for the ISAC service such that periodicity includes more resources dedicated to searching for a higher QoS target associated with the assistance information. The network provides information about a location of an object to one or more authenticated and allowed devices based on information provided in the assistance information, wherein the assistance information indicates a privacy level component that may be public, private, or group public, and wherein the location of the object is provided according to the privacy level. An object may make certain information about itself known to certain devices. For instance, others may be able to determine presence to a certain estimate such as 10, 20, or 50 meters but not velocity or angle. Other devices may signal an availability of providing velocity and altitude but with a different degree of accuracy in terms of location.

Subscribing to an integrated sensing service may be above and beyond subscribing for network services, wherein the subscribing includes registering 3GPP SIM-based devices and non-SIM enabled devices such as Bluetooth and Wi-Fi devices. The term SIM encompasses removable SIM cards and iSIM/eSIM implementations. The SIM-based devices and non-SIM-based devices are used for sensing services of the service. For instance, if a non-SIM based device is registered, such non-SIM based device may or may not have access to receive sensing information based on the non-SIM based device's willingness to participate in the sensing. A SIM or non-SIM based device may participate in sensing procedures and receive sensing determinant information so long as such device is willing to dedicate a QoS level or greater to providing ISAC. Dual SIM devices may use one SIM for sensing and another SIM for communications, and one of the SIMs may provide access to non-SIM devices.

Such devices may be granted a sensing pool for transmitting reference signals. The reference signals may be provided based on a pool of resources which is used for other services, such that multiplexing between those other services and transmitting sensing signals may be aligned. For instance, a UE-to-UE resource pool may coincide with reference signals of a sensing service based on a transmit direction of services associated with the pool and a particular QoS of the sensing service and the device-to-device service. Other services such as transmit/receive services may multiplex sensing signals.

A SIM device may have its own find-my-phone feature implemented such that the finding of a phone may be performed based on the SIM without relying on a phone or app running on a phone. For instance, a SIM may be provisioned to have a separate configuration for a location-based feature. The location feature may employ ambient cellular signals to indicate angle of arrival (AoA) or time of arrival (ToA) based on ambient signals to a cellular base station. If a user cannot find a phone, the user could provision another SIM of another phone with the same phone number and transmit a message via a phone having the provisioned SIM to locate the old SIM. A network server may process the request based on verification of the phone number of the newly provisioned SIM having matched an old SIM. For instance, if a base station can locate the lost SIM or phone, the server will provide information about the location to the new phone. SIMs may be identified based on one or more of an identifier assigned by the core network which may be a temporary mobile subscriber identity (TMSI). The SIM card identifier may be a subscription permanent identifier (SUPI) or a subscription concealed identifier (SUCI). The application layer identifier can be an electronic product code (EPC). A reprogrammable identifier may be used for identification, programming, and reprogramming over the air.

One problem is that a lost phone may be defective or unusable (without any power) and so it may not be findable via phone location methods. Instead, the phone may comprise circuitry itself which is locatable via backscattering. For instance, a phone modem may have its own backscatter charging circuitry which may or may not be coupled to the phone's antenna. In embodiments, the circuitry itself may function as an antenna or the chip may have its own dedicated antenna for AIoT functionality. The network may confirm that the unusable device is the correct device based on an authentication response provided by the phone based on a challenge provided to the phone. Based on the location of the phone, the network may determine, based on a lookup table or by pinging the phone for such information, a list of available channels for which the phone may be able to decipher. The phone may use ambient signaling to receive just enough power to wipe memory or burn a fuse such that the phone and its components are no longer usable absent the input of a code or by reprogramming.

A device configured to perform sensing may transmit and receive sensing signals in an unlicensed band. The sensing device may perform a listen-before-talk (LBT) procedure prior to transmitting reference signals for sensing. The LBT procedure may involve decoding control information of another device and decoding Wi-Fi related signaling. A sensing device may determine to preempt transmissions even if resources are determined to be busy, based on a QoS of the sensing transmission and a QoS of the signal considered for preemption. The preempting device may transmit a signal indicating preemption due to a need for sensing. The preemption may include resources used for transmitting the reference signals and resources used for receiving the reference signals. The preemption may include reserving preempted resources for the reference signals and reserving communication resources associated with the reference signals. For instance, a reference signal may be sent on X resources in the frequency domain and the communication signals may be sent on 2X resources at an offset time. Based on the QoS of sensing, a preempting device may convey the QoS when (before or after) the sensing signals are sent that way other receivers can decode the QoS and determine whether to even consider using the signals preempted for communication. For instance, a base station detects a potential collision of two vehicles and immediately sends a reference signal out in the direction of the collision which preempts other signals transmitted by others. The base station next informs that the QoS is high and therefore there is a high likelihood of it needing additional communication to indicate that a crash will most likely occur. This way, by receiving the QoS in advance, other devices learn the probability that future symbols, resources, or slots will be additionally preempted. Some devices may not be capable of receiving the QoS indication and some devices may not be capable of receiving a preemption indication, but some may be capable of one or both and may adjust their transmissions according to their capability, resources available, and QoS.

A UE, base station, or other device may send sensing assistance information and receive a grant for sending sensing reference signals. The assistance information may comprise various parameters including a preferred carrier frequency, bandwidth, antenna capability information (including gain), an altitude, angle, phase, potential reference signal receivers, number of symbols/slots/subframes/frames, duration, scheduling/control information, starting position, number and length of reference signals, type of reference signal, reference signal index, UE location, signal-to-noise ratio, cells detected in area, positioning method employed (ToA, AoA, etc.), Doppler frequency shift, whether position reference signal is used as a reference signal, and other relevant parameters. A sensing grant may be a configured grant, periodic grant, or one-time grant.

Joint integrated sensing and imaging methods may be employed in the system. For instance, it may be that a base station has limited sensing availability, for example the base station is in high demand for communication resources, and so the base station may employ 2D or 3D imaging methods to develop a rough landscape in terms of determining visibility and detecting blocked signaling. If sensing availability is below a threshold, the base station may employ greater use of a camera such that the base station may process images to detect a gross change of position before using the integrated sensing functionality to employ a fine change in position of objects, vehicles, people, and other targets. Audio signals may be employed in embodiments for either the gross change or for fine-tuning.

A method performed by a base station includes determining that resources available for transmission of an integrated sensing signal is below a threshold based on transmission of user data in a same direction, accessing at least a portion of a 2D or 3D map of the 3D environment based on a camera stored at the base station or at a remote station, and radiating into the 3D environment by a millimeter wave (mmWave) radio frequency (RF) transmitting device. The mmWave RF radiation is configured to interact with one or more of reflective surfaces, penetrable surfaces, and scattering surfaces of the 3D environment in a manner that produces a plurality of multipath components, wherein the radiating is performed based on objects identified in the 3D environment. The method includes receiving, by a mmWave RF receiving device, two or more of the plurality of multipath components as received multipath components, determining information for at least two of the received multipath components, the information comprising at least two members of a group that includes angle of arrival (AoA), angle of departure (AoD), time of arrival, relative time of arrival (RTA), and phase. The method includes computing a location of a mobile device as an absolute location and/or a relative location of the mobile device in the 3D environment by a computer processing comprising a ray tracing process that is based at least in part on the at least the portion of the 2D or 3D map and said information, and computing a visibility of at least one object which does not itself comprise a transceiver based on reception of the received multipath components at the base station or another base station. The method includes adjusting a transmission of the base station based on the visibility, wherein the adjustment comprises adjusting a periodicity of an SSB, one or more of the beams of an SSB, a null transmission of the base station (not transmitting a transmission), determining a conflict, determining to transmit data out of order for instance when a higher priority transmission is determined to be blocked, and indicating a blockage to at least one other station. The station which receives the indication adjusts transmission based on the indication, wherein the indication is further provided to other mobile stations based on such mobile stations subscribing to a particular service. The method may further include generating, based at least in part on the computed location of the mobile device and on the at least the portion of the stored 2D or 3D map, one or more of images or video of the mobile device's 3D environment, and providing the one or more of the images or the video of the mobile device's 3D environment to a display and/or to a storage of the mobile device for displaying on the display and/or storing in the storage. UEs may receive positioning information about the object detected from direct signaling or via either signal reflection or indirect signaling from a vehicle, UE, or base station.

Based on transmission blockage detected at the base station, roadside units or other base stations may broadcast information portions in directions missed by the blockage. For instance, RUs may broadcast SIB portions or other signals either available to vehicles traveling on the roadway or in other directions. RUs may operate in a backscatter mode, for instance when there is no power available to the RU. RUs may or may not be trusted. A gNB may provide RUs with dedicated resource pools for sensing and reporting of potential issues, and the gNB signals the resource pools in SIB. Periodicity of the SIB of RUs may be greater than SIB of the base station. RUs may use an omnidirectional beam versus express beamforming.

Law enforcement agencies may use ISAC devices to perform speed checks. Two or more methods could be employed, both methods may employ visual observation by a person in combination with base station-based sensing or more traditional radar unit-based sensing. A first method may comprise performing a registration procedure with a cellular network component, wherein the registration procedure comprises transmitting a message indicative that a roadside user has a certain access credential and such roadside user is associated with a UE and a camera system. The method includes providing camera images or video to a server, transmitting reference signals by a base station in range of a target object and receiving responses at the base station or at another base station, and providing information correlated with the responses to a server. The server ascertains the vehicle speed, direction, trajectory, location, lane of travel, and other parameters in accordance with an identifier associated with the object via the images or video, wherein the identifier associated with the object is associated with one of a set of objects in a database of identifier/object pairs. The method includes correlating a speed of the object with images of the object and providing one or more images of the object and the vehicle speed or other parameter to the UE via static images and/or via video feed, wherein an operator of the UE may associate the images or video with a time of day.

Handover may be performed for communication and/or sensing based on a beam-specific quality of a sensing cell and candidate sensing cells. For instance, sensing target detection by a serving cell becomes worse than an absolute threshold, sensing target detection by a candidate cell becomes an amount of offset better than sensing of the serving cell, sensing target detection by a candidate cell becomes better than an absolute threshold, or sensing of a target device by a serving cell becomes worse than absolute threshold1 AND sensing of a target device by a candidate cell becomes better than another absolute threshold2. Thresholds may be negotiated by base stations, for instance according to directions, locations, and speeds of target devices. Handover for sensing but not for communication purposes may occur in accordance with a blockage prediction. Thresholds may be modified when not all beams are available for sensing of a target at a particular instant or on a given frequency. Thresholds may be modified when energy exceeds a threshold, and devices may or may not perform certain actions herein.

Periodicity for sampling interference between sensing and communication should be communicated and negotiated among nodes. For instance, if interference is high for an object, another sensing device may perform sensing based on metrics and parameters of the object, determine the interference level, and if lower, the new base station may take over the sensing procedures. Determination of accuracy requirement may be based on negotiation between base stations. Potentially a broadcast message, wired or wireless, may be used to compute an accuracy based on certain parameters of the object including estimated location, travel speed, and other factors.

Monostatic and bistatic switching may be performed according to network energy saving requirements. For instance, if a base station exceeds a power threshold based on one or more transmissions of the base station, then a switch to monostatic or bistatic sensing may be triggered so long as the UE capability and QoS parameters are supportive of such a switch. The devices involved and UEs may report a capability to switch between monostatic and bistatic sensing per a network energy saving (NES) threshold, which may be negotiated. For instance, certain DCI formats may be based on the capability, and bit lengths of fields within may be configured based on RRC ISAC parameters.

One or more devices may report periodically sensing resource availability in a transmit direction, angle, and velocity in terms of one or both of receive and transmit (similar to a blanking interval). The device may receive a request to perform switching, evaluate whether the request is in conflict with existing sensing procedures performed monostatically and on behalf of other base stations, and accept or deny the request.

A non-transitory computer-readable medium may store instructions that, when executed, configure a base station to transmit a first message comprising a subframe allocation bitmap indicating a plurality of sensing resources which are configured as blank resources, transmit to a wireless device a first measurement subframe allocation bitmap indicating a first plurality of measurement subframes of a primary carrier that are not the plurality of blank resources, transmit to the wireless device a second measurement subframe allocation bitmap indicating a second plurality of measurement subframes of the primary carrier different from the first plurality of measurement subframes, and transmit a first blank transmission at a power level that is lower than during a subframe which includes one or more sensing signals. The first blank transmission spans one or more of a TTI, a symbol, a subframe, a control region, a data region, or any combination of the above, wherein the blank resources coincide with resources of a tracking device, a base station, a satellite station, a UAV, a plurality or group of UEs, a vehicle, a roadside unit, or similar devices.

An access point or non-AP station may transmit wide sensing signal beams in different directions to detect a target, detect the target with one or more of the wide sensing signal beams, and on a condition that a scheduled transmission does not exceed a certain traffic class or priority and a target is not detected in a beam direction that conflicts with the scheduled transmission, transmit a plurality of narrow sensing signal beams in a direction towards the target to track the target after the target has been detected. The station may increase a power of the narrow sensing signal beam to provide energy to the target, except for in scenarios in which power either meets or exceeds a threshold associated with a maximum transmission power, wherein the maximum transmission power is calculated based at least in part on a number of STAs receiving a transmission in an overlapping time period. The sensing transmission is dropped only on conditions that a certain priority threshold is exceeded of a scheduled transmission, wherein the sensing transmission may take precedence over the scheduled transmission based on a priority level of the sensing transmission, a size of the object, speed of the object, and an estimated length of time for which the scheduled transmission is expected. If the scheduled transmission is expected to be less than a given length, then the sensing transmission may be delayed.

Satellites may temporarily configure UEs to employ RF or integrated sensing in their decision-making to select resources for initial and retransmissions. For instance, the UE may use RF to detect the transmissions of other stations and may use such information to start backoff timers, however the UE may also use integrated sensing to determine blockages in its own transmission directions by transmitting only limited signaling. Such sensing transmissions may be overheard by other devices, and it may be inferred by the other devices that UEs are inclined to sense. For instance, a UE that transmits an ISAC signal may modulate such signal to convey a type of traffic to be transmitted. This way, other devices can determine a transmission type which may be associated with QoS, latency (QoS flow to DRB mapping), and in a certain direction. Satellites may configure a same or different pool for RF sensing and for ISAC (signal transmission). UEs may perform RF sensing using resources of the pool and then may perform ISAC using resources of the same or a different pool. If resources are occupied for some time and no other device is determined or estimated to be near or presenting a conflict, then associated resources may or may not be reselected.

Non-terrestrial network (NTN) or terrestrial network (TN) systems may convey dedicated access pools for providing and collecting assistance information from users in network and users out of network. It may be that a lead UE reports such information to a satellite, or it may be that a base station reports such information. In either case, the base station or satellite may need to be in control over the reporting resources, but they may also take the form of a pool of resources which are triggered from. NTN and TN networks may collaborate to provide sidelink pools to UEs. NTNs may always provide pools for in-service UEs and may provide out-of-coverage UE pools for which the UE may overwrite with a pool received from a satellite. For instance, if a UE reports a pool configuration to a satellite when the UE is out of TN coverage, the satellite may indicate a subpool or sub-elements within the pool for which to use while in the coverage area of the satellite (and not in coverage of a TN and for only a time period with which the UE is visible to the satellite). Before transmitting on a resource provided by the TN (and confirmed by the satellite), the UE may check satellite ephemeris information which is received with the subpool to determine if resources of the pool are valid. Depending on a latency of a transmission, the UE may transmit on a pool resource absent any sensing (based on random access), the UE may perform sensing before transmitting, or the UE may ping the satellite for a resource (on the condition latency is low enough to match). The UE may compare a desired latency to a latency of a certain satellite to determine if the satellite is too far to achieve the desired latency.

AI models may configure separate HARQ processing techniques. For instance, a first AI model may lean towards a standard such as LTE/NR redundancy version model, while a second AI model may accommodate an increased number of redundancy versions, configurable coding rates, different modulation and coding schemes, and other parameters. Different AI models may be applicable to a UE in a certain position in a cell or at a certain location or locations as determined based on sensing. Similarly, a UE or RAN node may configure another UE with an AIML model for performing sensing on behalf of the first UE or another UE.

A UE may transmit a request for sensing services to a network, the request including one or more parameters related to sensing and information for selecting an AIML model. The UE may receive an authorization response from the network based on the UE's subscription status and privacy settings, wherein the authorization response includes an indicator for receiving the AIML model. The UE may execute sensing functions locally on the UE based on the AIML model upon receiving authorization from the network, wherein the sensing functions include transmissions interleaved in slots in the time and frequency domain. The sensing functions.

A wireless device having a transceiver may be configured to perform joint integrated sensing and communications. The wireless device may comprise a processor configured to process sensing-specific symbol/slot structures; a transceiver configured to transmit a sensing signal based on the sensing-specific symbol/slot structures, wherein a time gap is specified before and after the sensing signal; wherein a symbol boundary of the sensing-specific symbol/slot structures is not impacted from a communication perspective.

The sensing-specific symbol/slot structures include a sensing-specific symbol/slot that includes sensing and communication signals transmitted in a time duplex manner in portions of a SBFD slot, wherein the portions represent a subset of the SBFD slot.

The sensing-specific symbol/slot structures include a sensing-specific symbol/slot that dedicate a subband to sensing only and another subband to communication only.

The sensing-specific symbol/slot structures include a sensing-specific symbol/slot that includes a gap that spans a frequency of the slot and a gap that spans a time component of the slot.

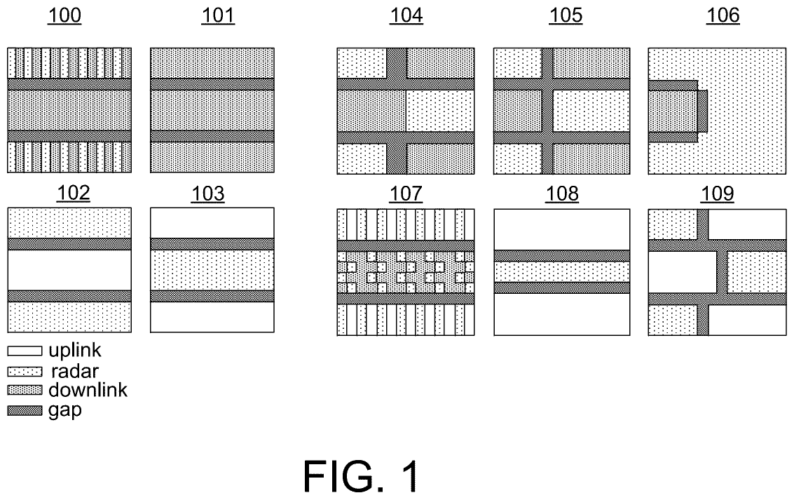

FIG. 1 shows example slot structures that include sensing and/or communications signaling. Structure 100 shows alternating sensing/downlink in upper and lower subbands with downlink in a middle subband. Structure 101 shows downlink in all subbands. Structure 102 shows sensing in upper and lower subbands with uplink in a middle subband. Structure 103 shows uplink in upper and lower subbands with sensing in a middle subband. Structure 104 shows radar, gap and downlink in upper and lower subbands with downlink and sensing in a middle subband. There is no gap in time shown in the middle subband although one may be used as is shown in structure 105. Structure 106 shows a more limited gap embodiment with additional sensing. Structure 107 shows alternating sensing and uplink in upper and lower subbands with an alternating pattern of radar and downlink in a middle subband. Structure 108 shows a narrower subband having sensing with upper and lower subbands dedicated to uplink. Structure 109 shows an upper and lower portion with sensing followed by uplink and a middle subband with uplink followed by sensing.

A transceiver may be configured to process a first in time downlink (DL) resource region followed by a second in time sub band full duplex (SBFD) time/frequency resource region comprised of DL, UL and DL regions and subsequently a third uplink (UL) resource region, wherein the DL resource region and the UL resource region are shorter in time duration than the SBFD resource region, wherein the SBFD resource region includes information spread over the region which is scheduled by a single DCI, wherein the UL resource region includes information scheduled separately. The information scheduled in the UL resource region is scheduled by a preceding DL region.

A method for sub-band full duplex (SBFD) wireless communications at a base station involves establishing multiple directional beams for communication with user equipment (UE). The base station establishes both a downlink directional beam and an uplink directional beam for full subband transmissions. Additionally, the system establishes first and second uplink directional beams, as well as first and second downlink directional beams, each configured for use along partial SBFD subbands. The UE reports quasi-colocation information for each beam relative to the others, enabling the base station to deduce appropriate beams based on these relationships. This quasi-colocation information is transmitted via PUCCH, MAC, or RRC signaling on periodic transmission resources, with the base station also reporting quasi-colocation information back to the UE.

In satellite transmission scenarios, the system may selectively avoid providing beams in areas where terrestrial networks (TN) have sufficient coverage. The terrestrial network reports parameters including cell density, total throughput, used power, and availability metrics that inform satellite node scheduling decisions.

The timing and configuration of HARQ feedback in SBFD systems depends on where downlink control information (DCI) is received within the slot structure. When DCI is received in the upper portion of an SBFD slot, individual HARQ feedback may be provided for each component carrier, even when the DCI schedules transmissions across multiple carriers. Conversely, when DCI is scheduled in a lower downlink portion, HARQ feedback for multiple component carriers may be transmitted on a single carrier. This technique applies more broadly to SBFD transmissions, where the reception or transmission location within the upper or lower portion of an SBFD slot can implicitly convey information through a single bit indicator about other control or data transmissions, including their locations.

Different user equipment capabilities must be considered in SBFD implementations. While some embodiments assume UEs can both transmit and receive within a single SBFD slot, restrictions may apply in scenarios involving mixed-capability devices. For instance, when one UE is half-duplex capable and another is full-duplex capable, a single DCI may schedule resources for both devices simultaneously.

In systems employing multiple subcarrier spacings, DCI scheduling behavior varies based on the carrier configuration. On a 15 kHz component carrier, the DCI may schedule SBFD transmissions on both the 15 kHz carrier and a 30 kHz carrier. DCI formats may be limited to scheduling the same slot type—for example, a DCI received in an SBFD slot might only schedule SBFD in one mode, while another DCI received in a downlink-only slot could schedule transmissions in dedicated uplink or downlink slots. On carriers with larger subcarrier spacing such as 60 kHz, a single DCI in one slot may schedule SBFD downlink and uplink transmissions across multiple slot types, including SBFD slots, downlink-only slots, and subsequent SBFD slots, due to the larger subcarrier spacing allowing more flexible scheduling. Different DCI formats apply in different scenarios, with certain formats only applicable in downlink-only slots and not in SBFD slots, while others can interchangeably schedule data across different slot formats.

Advanced HARQ mechanisms incorporate AI/ML model predictions to enhance transmission efficiency. In certain scenarios, HARQ transmission timing may be based on a fixed number of symbols or slots following downlink transmission. However, when an AI/ML model is enabled, the UE may transmit predictive HARQ feedback, determining successful reception based partially on successfully transmitted downlink data portions and predictive mechanisms such as the number of previously successfully decoded slots or frames. This predictive HARQ may not reflect actual reception status, prompting the UE to indicate it as anticipated HARQ with subsequent actual NACK or ACK transmission. The RAN node may choose whether to schedule retransmission based on the AI/ML indication and may defer actual retransmission until receiving true ACK/NACK feedback.

HARQ transmissions in SBFD embodiments, as in other implementations, can be based on various reference points including the first or last PDSCH/PUSCH transmission, symbol numbers relative to full uplink/downlink slots, the subcarrier spacing of the DCI, or the subcarrier spacing of the scheduled component carriers. When the next carrier lacks uplink capability or when the next slot is downlink-only, HARQ for multiple transmissions may be sent on one of the component carriers. Certain slots may be configured to contain only broadcast or unicast channels depending on whether subsequent slots can provide HARQ feedback, considering whether such slots have uplink portions and whether those portions conflict with other transmissions.

Scheduling on listen-before-talk (LBT) portions for SBFD may be performed based on AI/ML models that configure various settings and parameters. LBT procedures may operate on a slot-by-slot basis or on a symbol basis, where sub-slots are available but other symbols in the slot remain unavailable.

A wireless device may receive channel occupancy time (COT) structure indications from a network access node for COTs initiated on unlicensed carriers, or from associated or non-associated stations or other wireless devices within range. The COT structure indication specifies resources shared between downlink communication, uplink communication, radar communication, and sidelink communication. The device performs channel access procedures for these various transmission types within the COT resources. These resources are evaluated across multiple sub-bands within a SBFD slot, symbol, or frame. When one or more sub-bands are detected as busy while others remain available, the system transmits prioritized downlink, uplink, radar, or sidelink transmissions on available sub-bands while not transmitting lower-priority portions on unavailable sub-bands. Sensing-based transmissions may be woven into SBFD slot formats to enable flexible spectrum utilization.

A UE may transmit a request for sensing services to the network, including parameters related to sensing and information for selecting an appropriate AI/ML model. The network responds with an authorization based on the UE's subscription status and privacy settings, including an indicator for receiving the AI/ML model. Upon authorization, the UE executes sensing functions locally based on the AI/ML model. These sensing functions include transmissions interleaved in slots across time and frequency domains, incorporating both transmission during uplink portions and reception during downlink portions of slots. The transmitting and receiving is coordinated with other UEs operating the same AI/ML model. The UE transmits sensing data to the network for exposure to clients with the appropriate AI/ML model and can update its privacy profile related to sensing data through communication with network functions.

A base station may receive requests from UEs and transmit allocation messages indicating that portions of SBFD slots are shared resources for transmissions by multiple UEs. These allocation messages may designate whether the requesting UE is among those sharing the resource, and may allocate different SBFD slot portions to different UEs. Both the base station and UEs may employ these slots for sensing purposes.

Half-duplex slots containing radar signaling may be transmitted such that the physical layer transmit pattern or hopping sequence conveys information about the tracking device, transmitting device, or a device desiring to perform tracking. For example, when a UE desires to track another UE, it may request tracking from the base station, which then generates a coded sequence for transmission within the slot, multiple slots, or frame. This allows a tracked device to determine information about the device tracking it and potentially establish a network connection to the base station, another base station, or directly to the tracking UE via sidelink or through the base station. The sequence may contain a digital signature, random number, device identifier, or combination thereof.

A method for wireless communications at a first wireless device includes transmitting a message to a second wireless device indicating an observed full-duplex line-of-sight (LOS) view of a target device and the sub-band on which the observation occurs. The first device receives control signaling from the second device allocating uplink channel resources for uplink communications, downlink channel resources for downlink communications, and sets of LOS MIMO transmission modes for both uplink and downlink communications. The uplink and downlink channel resources may at least partially overlap in time, frequency, or both. The first device then communicates with the target device using the allocated resources and specified LOS MIMO transmission modes. The key distinction is that the first wireless device actively identifies and locates a target device and provides information about it before receiving resource allocations, which may or may not be SBFD resources. Such resources may include sidelink SBFD communication resources employing front-loaded control channels in time, frequency, or both, indicating resources for data portions of communications.

In various embodiments, one UE (UE1) instructs model download to another UE (UE2). These UEs may operate on the same or different carriers and may or may not be owned by the same party. The AI/ML model may be transferred via Bluetooth when devices are in range, WiFi when within range of an access point, and via cellular uplink/downlink when neither condition is satisfied. UEs may be adapted to receive AI/ML models for satellite networks, WiFi networks, security-only networks, emergency networks, and other network types, regardless of whether the model is for operation on that specific network. UE1 provides an urgency parameter indicating whether the model should be downloaded immediately or at a later date when the UE meets threshold network and device parameters, such as a threshold battery level.

An over-the-top (OTT) server may verify a UE subscription before providing AI models based on phone number verification, such as SMS-based authentication by sending an SMS to the UE, receiving a confirmation code, and then delivering the AI model, which may be a hardware or software model. AI models may or may not be SIM-specific, with inter-SIM sharing of models being preferable in some scenarios.

In WPAN and WLAN embodiments, a transmitter might employ TDD mode and switch to SBFD mode based on specific header, data, and trailer formats. Low-capability devices may only receive Type A modulation, while high-capability devices can receive and transmit two or more different modulation formats, including Type A, in the data portion. Header and trailer portions may also operate in SBFD mode. Devices unable to process certain modulation types in the data portion may be configured to skip reception or transmission. Type A modulation may involve on-off keying of an ambient signal, while Type B modulation may or may not modulate the ambient signal and could instead employ higher-order modulation of another ambient signal or a non-ambient transmitted signal. Other SBFD formats may be used in data segments and employed interchangeably subject to the disclosed ordering conditions.

When one or two DCIs are provided on the downlink at the start of a slot, the DCIs may indicate that one UE uses the uplink while another uses a subsequent downlink portion. The DCI may schedule the current slot, following slots, or some combination. This can be accomplished with Boolean indicators (0 for downlink, 1 for uplink) for each DCI. Based on the slot format, UEs determine which portions to receive or transmit in. Alternatively, with a single DCI, both UEs may transmit or receive in portions indicated by that single DCI.

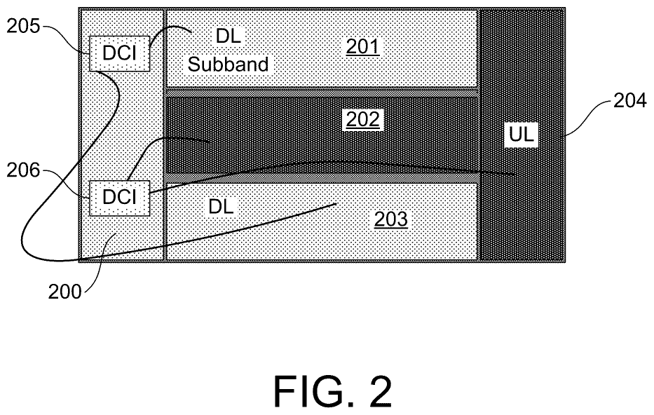

FIG. 2 shows an embodiment wherein time/frequency resources are divided into sets such that a first downlink slot may be a set, a series of SBFD slots may be divided into sets including i) an upper band DL set, ii) a middle band UL set and iii) a lower band DL set. These sets span slots over time or alternatively, may encompass a single slot in the DL or UL direction. In the example shown, DL set 200 includes DCI 205 and DCI 206. DCI 205 schedules information in the DL subband 201 and in DL SB 203 which have are sets that occupy a longer time duration than DL set 200 and UL set 204. DCI 206 may schedule resources in UL set 202 and UL set 204.

A network may configure maximum and minimum orthogonal cover code (OCC) lengths and DMRS sequences on a time basis across a sliding number of slots, consistent with or irrespective of expected slot format. The network may configure DMRS differently in SBFD slots compared to dedicated downlink or uplink slots, for instance by varying the location in frequency or on a beam basis. DMRS configuration may also differ depending on slot type change allowances or restrictions for different SBFD slot formats, as UEs have varying capabilities to process transitions between different SBFD slot formats.

Blanked DMRS may or may not coincide with opposite DMRS (for uplink or downlink). Embodiments may alternate between one and two modulation reference signals in a slot, number of slots, number of subframes, or on a frame basis, depending on how many demodulation signals are used for uplink or downlink. Demodulation reference signals may be configured based on TDD uplink/downlink patterns. Uplink and downlink DMRS may be optionally removed from a slot based on AI/ML model decisions or based on whether adjacent slots require DMRS. UEs may process DMRS-containing symbols, slots, or subframes over gaps, depending on RRC configuration. Various formats may be applicable depending on TDD uplink-downlink configuration, noting that gaps may be needed between downlink or downlink/radar symbols to aid low-complexity devices in switching from previous SBFD formats, though these gaps may be removed entirely for more capable devices.

Quantization may limit reporting to one or two bits in certain embodiments. A UE may receive a phase reporting configuration from a network entity and generate a phase report comprising phase measurements of cross-link interference (CLI)-based sensing resources. The phase reporting configuration includes information on the granularity of reported phase quantization and reporting density. The report is transmitted on aperiodic resources determined based on resource availability. When transmitted on full uplink resources such as TDD uplink resources, the report uses a higher number of bits compared to transmission on an uplink subband of an SBFD slot. Similarly, CLI reports for non-SBFD channels are larger than those for SBFD channels.

A first base station stores an SBFD subframe partition configuration that includes interlace allocation of downlink and uplink resources configured as semi-static or dynamic resources. The base station transmits signals according to the downlink resource allocation, where the downlink resource is time, beam, and/or frequency division orthogonal to downlink resources allocated to a second base station. The base station type may be a macrocell base station of various power classes, femtocell, picocell, LEO satellite, GEO satellite, or UAV, with different base station types coordinating their SBFD resource allocations.

A RAN node may employ an AI/ML model to predict necessary on-demand system information blocks (SIBs) based on device type or other parameters such as previously requested non-periodic SIBs. Alternatively or in combination, requests may be made on SBFD uplink resources indicating which on-demand SIBs are required. When a UE receives PBCH on an SBFD portion and transmits RACH, the node may associate the UE as SBFD-capable based on the resources employed for RACH transmissions. The node may schedule a SIB upon determining that an SBFD UE is attempting to connect, with SIBs provided in various SBFD formats. Network nodes may vary the number of synchronization signal blocks (SSBs) depending on TDD configuration and frequency or frequency range.

SBFD-SIB1 configuration is indicated via PBCH and MIB, including subcarrier spacing and SBFD slot configuration patterns for SIB1 reception, allowing UEs to learn the SBFD slot formats for receiving SIB1. The configuration may indicate that SIB1 should be retrieved on-demand only, after RACH and upon UE request. SSBs may or may not convey the same information in each SSB within a set. Various slot formats containing SSBs within SBFD designs may repeat in frequency and time as necessary to form complete SSBs, with potentially different numbers of symbols in different frequency portions and time extensions varying between SBFD slots and regular TDD slots.

PSS, SSS, sensing signals, and other reference signals may be transmitted according to comb-like structures where the comb structure is included in more or fewer resource blocks than other signals received in time, frequency, or beam. These signals may be always transmitted or transmitted on-demand, with a configured number of symbols or slots indicating delta time periods or frequency offsets between always-on and on-demand associations. Measurement reports may be sent to the transmitting node indicating offsets in frequency, time, or beam based on reception of PSS, SSS, and other reference signals. Periodic and aperiodic CSI-RS transmissions may be made in downlink portions of SBFD slots, time, frequency, code, or beam multiplexed with the aforementioned reference signals. The presence or detection of reference signals may reconfigure the wireless environment, cause retransmission of other signals, or instruct AI/ML model training.

In some scenarios, PSS, SSS, and PBCH may be longer in time than in frequency, with lengths varying from SSB to SSB. When full downlink slots are employed, these signals may be transmitted two or three times per slot depending on conditions. When SBFD slots are employed, these transmissions may be elongated in time. Different beams may be used for each set of signals, with different beams used across time and frequency. MIMO mechanisms may employ different beams for different portions, enabling transmission of two, four, or six beams over a single slot. Omnidirectional beams may be used in some slots with subsequent TDD or SBFD slots employing directional beams, or vice versa. UEs may measure candidate beams provided over one or more slots and respond with preferred beam indications or other channel quality information using uplink portions of another SBFD slot, identified by the beam, beam pattern, or symbol location transmitted in the downlink portion.

Uplink portions of SBFD slots may or may not be dedicated for SIB requests, including requests for SIB1 transmission. The number of SS blocks transmitted in time and frequency domains may vary, with possibilities including two differently beamformed SS blocks transmitted simultaneously using the same or different beams via space-time coding. PBCH may be received in accordance with time, frequency, or beam components of PSS and SSS. RAN nodes may omit SSS during SBFD or other slot types. SSB formats or configurations may differ based on frequency band range, with variations between lower and higher frequency bands.

SBFD slots employing PBCH or other transmission types may be scrambled differently than TDD uplink/downlink dedicated slots, potentially using different scrambling seed values. PBCH transmitted on SBFD slots may convey different information about the location, periodicity, or numerology of SIB1 or other SIBs. PBCH may provide information about TDD patterns, including SBFD patterns, for SIB1 reception and may indicate uplink portions of SBFD slots for making SIB1 requests. SIB1 or other transmissions may be limited to TDD slots, which in itself may convey information to receivers about remaining system information.

Subsequent to SSB transmission, a base station or satellite station may transmit bundled downlink control information comprising multiple DCIs to a UE via one physical downlink control channel (PDCCH) or via one PDSCH of an SBFD slot portion. The bundled DCI may span a single slot, multiple slots, portions interleaved in multiple slots, or be dedicated only to downlink slots and spread over multiple downlink slots. The system transmits downlink data, including remaining system information, via multiple physical downlink shared channels scheduled by the bundled DCI. The multiple DCIs are sequentially arranged within the bundled DCI in a time, frequency, or beam-separated manner, potentially using space-time block coding. The bundled DCI may schedule uplink transmissions as well as downlink data transmission. The system receives requests for additional system information on scheduled downlink resources and may schedule the additional system information for transmission by another station.

In multi-carrier SBFD systems, DCI must indicate carrier information and binary indicators of which subband portion is employed for corresponding data transmissions. A TDD-only carrier may schedule DCI on an SBFD carrier, requiring indication of which carrier to employ and, if the carrier is SBFD, which subcarrier signal is used—information that may be omitted if an SBFD carrier is not used for scheduling. The SBFD carrier indicator may use different numbers of bits depending on the slot format employed for corresponding information transmission, such as one bit for SBFD slot formats with two uplink portions or two bits for formats with up to four downlink portions. For multiple slot scheduling, the indicator may convey which downlink portions are employed across multiple slots over a frame or alternative scheduled period.

A UE may receive system information from a first satellite indicating RACH transmission timing for both the first satellite and a second satellite. The UE may receive a paging message on a downlink portion of an SBFD slot from a first satellite in one orbital space and send a RACH message to another satellite to establish a connection. The RACH message is sent on resources associated with and configured according to the resources on which the paging message was received, with resource information selected based on the system information.

Joint transmission in satellite systems may employ one TDD link and one SBFD link. For instance, DVB and 3GPP RAN systems may be employed together where a DVB channel is configured for SBFD and a 3GPP RAN channel is configured for SBFD, with the uplink subband portions of each channel being different in size or scheduling frequency. TDD portions or FDD portions may coexist simultaneously.

SBFD may be implemented in 802.11 type access scenarios. A first station (STA) receives a sub-band full duplex trigger frame from an access point (AP) that has established a transmission opportunity (TXOP) with a second STA on a channel bandwidth including 320 MHz, 640 MHz, 1280 MHz, or 2560 MHz. The SBFD trigger frame includes an indication that the AP is establishing an SBFD channel with one or more additional STAs and an indication of the TXOP duration. In response, the first STA transmits uplink frames indicating participation within a predefined duration and performs SBFD transmissions in uplink and downlink. These SBFD transmissions occur on portions of the channel bandwidth where uplink and downlink subband portions may or may not be evenly divisible by 320 MHz and which change in size during the TXOP, such as an uplink portion becoming larger while a downlink portion becomes smaller in frequency, or vice versa.

A first device comprising a station detects a cross-link interference event involving an uplink or downlink transmission that will interfere or is interfering with its uplink or downlink communication session with a second device comprising an access point or another station. The first device transmits an identification of the interference event to the second device, either directly or via a relay device. The first device receives a selection of an operation mode from a plurality of modes, including a non-SBFD operating mode, responsive to the identified interference event. The communication session continues utilizing the selected operation mode.

A station receives a Reduced Neighbor Report from an access point containing a Neighbor AP Information field with time and frequency information regarding the target beacon transmission time (TBTT) of a frame transmission by a neighbor AP. The frame transmission is made on a downlink portion of the subband during a time when the neighbor AP is simultaneously receiving information from another STA.

A station configured to perform SBFD multi-link operations by communicating both uplink and downlink on multiple links concurrently receives a frame from a first AP multi-link device (MLD) indicating affiliation with a multi-MLD (MMLD) comprising multiple AP MLDs, with at least one AP MLD configured for SBFD operation. The station transmits a message indicating support for MMLD operations when concurrently communicating on multiple links and receives information related to the plurality of AP MLDs for establishing communications on the multiple links.

A station's receiver receives a fast initial link setup (FILS) discovery frame from an access point that the station is not associated with. The FILS discovery frame includes a frame transmission countdown field, operating bandwidth of at least one link configured for SBFD operation, indications of band portions dedicated to uplink and downlink, number of supported spatial streams, supported modulation and coding schemes for uplink and downlink portions (jointly or individually), and indications of whether authentication and security are implemented individually or separately on each subband portion.

A station configured to perform sounding procedures receives a beacon frame from an access point on a subband of an SBFD channel, where the beacon frame includes an indication of at least one punctured subchannel. The station receives a null data packet announcement (NDPA) frame including an indication of subchannels for measuring channel characteristics, which include at least one non-punctured subchannel. After receiving an NDP frame, the station transmits a feedback report frame including channel state information (CSI) feedback on an uplink component of the SBFD channel. The CSI feedback is based on measurements performed on the received NDP frame using the indicated subchannels and includes information about cross-link interference. The AP derives information on the uplink portion of the SBFD channel based on pilot signals provided in the uplink transmission along with or interspersed with the CSI feedback transmission.

A wireless transmit/receive unit (WTRU) processor receives, via radio resource control (RRC) signaling, an indication of a set of reference frequency resources for which uplink cancellation could occur. These reference frequency resources span more than one channel in the frequency domain, including SBFD slots and uplink or downlink slots. The WTRU receives an indication of at least one priority for which uplink cancellation is applicable, separately according to uplink/downlink slots and SBFD slots, and an allocation for a configured grant allocating resources among both SBFD slots and uplink/downlink slots. The allocation includes frequency allocation, time allocation, and priority indices per slot type for the configured grant.

The WTRU receives a physical downlink control channel (PDCCH) transmission containing downlink control information (DCI) scrambled with an RNTI associated with one or more SBFD configured UEs. The DCI includes cancellation indication (CI) information indicating that a subset of the reference frequency resources are subject to uplink cancellation in one or more time symbols. The WTRU cancels at least part of an uplink transmission associated with the configured grant based on the CI information, the frequency and time allocations for the configured grant, the priority index for the configured grant, and the indication of priorities for which uplink cancellation is applicable received in the RRC signaling.

A WTRU receives configuration information including information regarding configured grant uplink resources within one or more SBFD slots. The WTRU determines a hybrid automatic repeat request (HARQ) process identifier based on the number of SBFD slots per frame and the number of uplink subbands in a slot, subframe, or frame. The WTRU transmits an uplink transmission using the determined HARQ process ID and the configured grant uplink resources. A base station or another station determines a HARQ process ID based on the number of SBFD downlink portions. A cancellation DCI may cancel transmissions in both downlink and uplink, assuming those transmissions are on SBFD slots and preceding or following slots are TDD slots, with the cancellation DCI responsive to URLLC transmissions occurring on both TDD and SBFD slots.

A WTRU processor and transceiver receive configuration information defining a first search space set and a second search space set. The first search space set comprises one or more search spaces, each containing multiple physical downlink control channel (PDCCH) candidates, as does the second search space set. The configuration information indicates that the first and second search space sets are linked, where the first search space is an SBFD search space and the second is a TDD search space, or both are SBFD search spaces. The WTRU receives downlink control information by detecting a first transmission using at least one PDCCH candidate of the first search spaces, providing a first repetition of the DCI, and detecting a second transmission using at least one PDCCH candidate of the second search spaces, providing a second repetition of the DCI. The WTRU decodes at least one of these transmissions. The linking may be applied where each search space set corresponds to a different numerology, with transmissions performed using the same or different modulation and coding schemes as indicated by the DCI. The DCI indicates at least one transmission on an SBFD portion, potentially with an RNTI such that a group of UEs receives the DCI, with some users receiving downlink transmissions and others transmitting uplink based on the DCI.

SBFD signals, including periodic signals and reference signals for channel estimation, synchronization, and beamforming (such as PSS, SSS, CRS, DMRS, PTRS, and others), may be dynamically cancelled, or certain segments or periods of periodic signals may be cancelled using DCI, MAC, or RRC signaling. Transmission cancellation may be performed on a cross-carrier, cross-frequency, or other basis. An SBFD slot may cancel a transmission on FR1 or FR2, TDD, or FDD bands and may be applicable for cancelling resources scheduled on aggregated carriers. UEs may indicate that a gNB should cancel a periodic transmission, and UEs may cancel scheduled transmissions to other UEs. Cancelled transmissions may include any transmission type provided by 3GPP specifications.

Alternatively or in combination with transmission cancellation, there may be a need to cancel measurement gaps to enable various transmissions. A sliding window may be incrementally applied over time to detect, perform measurements, and identify the probability of a next measurement gap being necessary. When, during the sliding window, one measurement is in range above a threshold, a counter may be used to determine the number of measurements that should be skipped. Such counters may be periodically reported over a communications link along with one or more measurement results. A gNB may consider such information when indicating measurement gap skipping via DCI, MAC, or RRC instructions. Cancellation information for groups of users may be indicated together, enabling efficient coordination of measurement and transmission activities across multiple devices.

What is claimed is:

1. A wireless device configured to perform joint integrated sensing and communications, the wireless device comprising:
a processor configured to process sensing-specific symbol/slot structures;
a transceiver configured to transmit a sensing signal based on the sensing-specific symbol/slot structures, wherein a time gap is specified before and after the sensing signal;
wherein a symbol boundary of the sensing-specific symbol/slot structures is not impacted from a communication perspective.

2. The wireless device of claim 1, wherein the sensing-specific symbol/slot structures include a sensing-specific symbol/slot that includes sensing and communication signals transmitted in a time duplex manner in portions of a SBFD slot, wherein the portions represent a subset of the SBFD slot.

3. The wireless device of claim 1, wherein the sensing-specific symbol/slot structures include a sensing-specific symbol/slot that dedicate a subband to sensing only and another subband to communication only.

4. The wireless device of claim 1, wherein the sensing-specific symbol/slot structures include a sensing-specific symbol/slot that includes a gap that spans a frequency of the slot and a gap that spans a time component of the slot.

5. A transceiver configured to process a first in time downlink (DL) resource region followed by a second in time sub band full duplex (SBFD) time/frequency resource region comprised of DL, UL and DL regions and subsequently a third uplink (UL) resource region, wherein the DL resource region and the UL resource region are shorter in time duration than the SBFD resource region, wherein the SBFD resource region includes information spread over the region which is scheduled by a single DCI, wherein the UL resource region includes information scheduled separately.
wherein the information scheduled in the UL resource region is scheduled by a preceding DL region.

6. A wireless device configured to perform joint integrated sensing and communications, the wireless device comprising:
a processor configured to process sensing-specific sub band full duplex (SBFD) symbol/slot structures; and
a transmitter configured to transmit a sensing signal in accordance with one or more of the SBFD symbol/slot structures.
